(19) United States
(12) Patent Application Publication
(10) Pub. No.: US 2014/0273580 A1
(43) Pub. Date: Sep. 18, 2014

(54) Connector Assembly with Dual Metal to Metal Seals

(71) Applicant: KEMLON PRODUCTS & DEVELOPMENT CO., LTD, Pearland, TX (US)

(72) Inventors: Chris S. Ring, Houston, TX (US); Russell K. Ring, Friendswood, TX (US); Matt A. Jannise, Friendswood, TX (US)

(73) Assignee: KEMLON PRODUCTS & DEVELOPMENT CO., LTD., Pearland, TX (US)

(21) Appl. No.: 13/840,118

(22) Filed: Mar. 15, 2013

(51) Int. Cl. H01R 13/52

(52) U.S. Cl. CPC H01R 13/5219
USPC 439/283

(57) ABSTRACT

An apparatus for providing dual metal to metal seals for sealing tubing encapsulated conductors or hydraulic tubing is disclosed. The apparatus utilizes a unitary, metal seal body that provides an external sealing surface for a first metal to metal seat and an extended portion that energizes a second metal to metal seal. The unitary metal seal body may have a forward end, a midsection, a back end, and an internal passageway proceeding from the back end through the forward end for receiving a tubing encapsulated conductor or hydraulic tubing. The unitary, metal seal body may utilized together in a system with a forward nut, a rear nut, an electrical or tubing connection housing, and three metal ring seals.

### CROSS-REFERENCE TO RELATED APPLICATIONS

None.

### STATEMENTS REGARDING FEDERALLY SPONSORED RESEARCH OR DEVELOPMENT

None.

### REFERENCE TO A MICROFICHE APPENDIX

None.

### BACKGROUND OF THE INVENTION

1. Field of the Invention

The present invention relates to a connector for tubing. More particularly, the present invention relates to dual metal to metal seal connectors for use with tubing encapsulated electrical conductors and hydraulic tubing.

2. Description of the Related Art

In oil and gas production, completion is a general term used to describe the process of making a well ready for production. One important part of completion is the installation and connection of down-hole instrumentation.

Down-hole instrumentation measures well parameters such as dip conductivity, temperature, pressure, etc. One method for providing power and data communications to the down-hole instrumentation systems is to run an electrical cable from the surface to the down-hole system instrumentation. The electrical cable typically consists of two main sections. One main section is coupled to the down-hole instrumentation system and the other main section is coupled to a control module at the earth's surface. To establish power and data communications between the down-hole system and the control module, the two sections of the electrical cable must be connected. The connection of these two sections is typically accomplished through a device commonly known as a cable head which allows an electrical connection to be made, while at the same time providing a seal between the electrical conductors and the outside environment.

The design of the cable heads is extremely important to the safety and reliability of oil and gas wells. These devices must typically provide a robust, long term connection as they are permanent installations and expected to last upwards of twenty years. In many circumstances if the connected instrumentation fails, it cannot be replaced and must be abandoned in the event of a failure.

While the design of robust cable heads has long been important, recent issues have led to a need to develop a more safe and reliable cable head. For example, the explosion and sinking of the Deepwater Horizon rig in the Gulf of Mexico resulted in tremendous injury and loss of life, property and environmental damage. As a result, companies involved in oil and gas drilling and production, as well as government regulators, are looking for ways to increase the safety and reliability in all facets of the well system. It seems only a matter of time before an enhanced safety cable head will be required.

Traditional cable heads have utilized a single metal to metal seal to prevent leakage. While this may have been sufficient in many cases, there have been past attempts to provide a backup to the single seal. For example, it has been known to utilize a secondary elastomeric seal, such as an elastomer O-ring, along with a metal to metal seal. Unfortunately, elastomeric materials tend to degrade over time making their use in permanent installations somewhat problematic. Other attempts to enhance the single metal seal designs have included cable head systems that require welding of certain joints on the rig floor. These prior art systems have tremendous disadvantages in that welding on the rig floor, an explosive environment, presents a safety hazard, as well as requiring significant time involved in the assembly and welding process.

Some prior art attempts to provide cable heads with dual metal to metal seals have been made. For example, it has been known to use a metal ferrule in combination with a metal cone type seal. The use of the cone type metal to metal seal is problematic in that the conical seal rotates on the surface that it is sealing and can therefore damage the sealing surface. While this type of seal may be useful to keep out mud and debris, it does not provide a strong, tight seal. Other prior art attempts have included combining a C-ring seal with a metal ferrule seal. These prior art systems are not generally effective at preventing leaks, particularly at higher pressures. Also, because of the nature of these C-ring systems, they are more expensive and difficult to manufacture.

As can be seen, it would be desirable to have an improved cable head that can provide a robust and reliable seal without creating additional safety, manufacturability, and expense concerns.

### BRIEF SUMMARY OF THE INVENTION

The present invention includes an apparatus and a method for providing dual metal to metal seals for sealing tubing encapsulated conductors or hydraulic tubing. The apparatus utilizes a unitary, metal seal body that provides an external sealing surface for a first metal to metal seal and an extended portion that energizes a second metal to metal seal.

In a preferred embodiment, the unitary metal seal body has a forward end, a midsection, a back end, and an internal passageway proceeding from the back end through the forward end for receiving a tubing encapsulated conductor or hydraulic tubing. An external surface of the seal body midsection comprises a metal sealing surface for a first metal to metal seal and the forward end comprises a surface for energizing a second metal to metal seal.

In another preferred embodiment, the unitary, metal seal body is utilized together in a system with a forward nut, a rear nut, an electrical or tubing connection housing, and three metal ring seals. Preferably, the forward nut has a forward portion with a male threaded connection on an external surface, a rear portion with external shoulders to assist with rotation of the forward nut, and an internal passageway proceeding from the rear portion through the forward portion. Preferably, the rear nut has a forward portion with a male threaded connection on an external surface, a rear portion with external shoulders to assist with rotation of the rear nut, and an internal passageway proceeding from the rear portion through the forward portion for receiving a tubing encapsulated conductor or hydraulic tubing. Preferably, the metal ring seals are metal ferrules or, alternatively, one or more metal C-ring seals may be utilized.

In a preferred embodiment, the forward end of the unitary seal body extends through the internal passageway of the forward nut. The sealing surface on the external surface of the seal body midsection engages with the first metal seal ring to provide a first metal to metal seal. The forward portion of the forward nut compresses said first seal ring to energize this metal to metal seal. The forward end of said seal body compresses the second metal seal ring to create a second metal to metal seal between said second seal ring and the tubing encapsulated conductor or tubing. Preferably, there is a female threaded connection in the internal passageway of the seal body near the back end for engagement with the male threaded connection of the forward portion of the rear nut. The forward portion of the rear nut compresses the third metal seal ring to create a metal to metal seal between said third seal ring and the tubing encapsulated conductor or tubing.

The preferred embodiments of the present invention provide significant safety and reliability for permanent seals such as are needed with down-hole instrumentation or subsea applications. These embodiments are particularly well suited for high pressure (5,000 to 40,000 psi) applications. The preferred systems also provide additional safety as welding is not required on drilling rigs during installation which further provides additional productivity and reliability. The preferred system design is flexible and can be used with various sizes of tubing or tubing encapsulated conductors and with various materials which allows for installation in various different environments, including corrosive environments.

### BRIEF DESCRIPTION OF THE SEVERAL VIEWS OF THE DRAWINGS

A better understanding of the present invention can be obtained when the following detailed description of the disclosed embodiments is considered in conjunction with the following drawings, in which:

FIG. 1(a) is a longitudinal view of a preferred embodiment of a unitary, metal seal body and a second metal seal ring (in this case a ferrule) of the present invention.

FIG. 1(b) is a longitudinal section view of a preferred embodiment of a unitary, metal seal body of the present invention.

FIG. 2(a) is a longitudinal view of a preferred embodiment of a forward nut and a first metal seal ring (in this case a ferrule) of the present invention.

FIG. 2(b) is a longitudinal section view of a preferred embodiment of a forward nut of the present invention.

FIG. 3(a) is a longitudinal view of a preferred embodiment of a rear nut and a third metal seal ring (in this case a ferrule) of the present invention.

FIG. 3(b) is a longitudinal section view of a preferred embodiment of a rear nut of the present invention.

FIG. 4(a) is a longitudinal view of a preferred embodiment of an electrical connection housing of the present invention.

FIG. 4(b) is a longitudinal section view of a preferred embodiment of an electrical connection housing of the present invention.

FIG. 5 is a longitudinal view of a preferred embodiment of a termination end of a tubing encapsulated conductor as used with the present invention.

FIG. 6 is a longitudinal section view of a preferred embodiment of an electrical connector assembly of the present invention in its assembled state.

FIG. 7 is a longitudinal section view of a preferred embodiment of a tubing connector assembly of the present invention in its assembled state.

FIG. 8 is a longitudinal section view of an alternate preferred embodiment of an electrical connector assembly of the present invention in its assembled state.

### DETAILED DESCRIPTION OF THE INVENTION

The present invention includes an apparatus and a method for providing dual metal to metal seals for sealing tubing encapsulated conductors or hydraulic tubing. The apparatus utilizes a unitary, metal seal body that provides an external sealing surface for a first metal to metal seal and an extended portion that energizes a second metal to metal seal.

In a preferred embodiment of the present invention, a connection assembly is formed from a unitary, metal seal body 20, together with a forward nut 50, a rear nut 70, an electrical connection housing 90 or a tubing connection housing, and three metal ring seals 40, 60, and 80.

As can be seen in FIGS. 1(a) and (b), the preferred embodiment of the invention includes a unitary, metal seal body 20 that has a forward end 28, a midsection 26, a back end 22, and an internal passageway 25 proceeding from the back end through the forward end for receiving a tubing encapsulated conductor or hydraulic tubing. Utilization of a unitary seal body prevents the possibility of leaks and also avoids welding on the rig floor which is disfavored.

This preferred embodiment also includes a second metal ferrule seal 40, preferably with a front portion 44 and a rear portion 42. In one particular preferred embodiment designed for 0.250 inch tubing, the second metal ferrule seal 40 comprises a ¼ inch Swagelok® front ferrule and a ¼ inch Swagelok® rear ferrule. Similar metal ferrules manufactured by other companies are equally acceptable for use in this invention.

The forward end 28 of the preferred embodiment includes a male threaded connection for threaded engagement with the electrical connector housing 90. The outermost surface 30 of the forward end 28 of seal body 20 directly engages the front portion 42 of the metal ferrule 40.

The back end 22 preferably comprises a hexagonal surface that provides a means for rotating and tightening the male threaded connection of the forward end 28 into the electrical connector housing 90. In a preferred embodiment, the hexagonal surface is a ⅝ inch hexagon. As will be recognized by those of skill in the art, in a preferred embodiment, the back end 22 may also include a recessed portion around the outer surface into which an O-ring 32 can be inserted to assist with pressure testing prior to installation.

The mid-section 26 of the seal body 20 provides the sealing surface for the first ferrule seal 60. Preferably, the sealing surface is a smooth, well machined surface without significant flaws to allow for a strong tight seal. As will be recognized by those of skill in the art, a good surface finish is important for metal to metal seals. Preferably, the sealing surface of mid-section 26 includes a surface finish of 16 to 32. Preferably, the tubing is also polished to have the best possible finish as well. In a preferred embodiment of the invention designed for 0.250 inch OD tubing, the outside diameter of the mid-section 26 is about 0.446 inches with a length of about 1.55 inches.

The internal passageway 25 extends through the length of the seal body 20 to allow the tubing to be passed through the seal body. As will be recognized by those of skill in the art, for 0.250 inch OD tubing, the diameter of the passageway should be slightly larger to allow tubing insertion yet tight enough to allow a tight seal to be formed by the metal to metal seals. The portion of the internal passageway 25 in the back end 22 of the seal body 20 preferably includes a female threaded connection 36 for allowing threaded engagement of rear nut 70 and a conical section 34 to accommodate the third metal ferrule 80 when engaged with the tubing.

As shown in FIGS. 2(a) and (b), the preferred embodiment of the invention includes a forward nut 50 having a forward portion 54 with a male threaded connection on an external surface, a rear portion 52 having external shoulders to assist with rotation of the forward nut 50, and an internal passageway 58 proceeding from the rear portion through the forward portion.

This preferred embodiment also includes a first metal ferrule seal 60, preferably with a front portion 64 and a rear portion 62. In one particular preferred embodiment designed for 0.25 inch tubing, the first metal ferrule seal 60 comprises a ¼ inch Swagelok® front ferrule and a ¼ inch Swagelok® rear ferrule. Similar metal ferrules manufactured by other companies are equally acceptable for use in this invention.

The forward portion 54 of the preferred embodiment includes a male threaded connection for threaded engagement with the electrical connector housing 90. The outermost surface of the forward portion 54 of forward nut 50 directly engages the rear portion 62, and indirectly the front portion 64, of the metal ferrule 60 to force a seal between the metal ferrule 60 and the sealing surface on the mid-section 26 of the seal body.

The rear portion 52 of forward nut 50 preferably comprises a hexagonal surface that provides a means for rotating and tightening the male threaded connection of the forward portion 54 into the electrical connector housing 90. In a preferred embodiment, the hexagonal surface is a ⅝ inch hexagon.

The internal passageway 58 extends through the length of the forward nut 50 to allow the seal body mid-section 26 to be passed through the forward nut 50. As will be recognized by those of skill in the art, the diameter of the passageway 58 should be slightly larger than the OD of mid-section 26 to allow mid-section 26 to be inserted yet tight enough to slidingly engage mid-section 26.

As shown in FIGS. 3(a) and (b), the preferred embodiment of the invention includes a rear nut 70 having a forward portion 78 with a male threaded connection 76 on an external surface, a rear portion 72 having external shoulders to assist with rotation of the rear nut 70, and an internal passageway proceeding from the rear portion through the forward portion.

This preferred embodiment also includes a third metal ferrule seal 80, preferably with a front portion 84 and a rear portion 82. In one particular preferred embodiment designed for 0.250 inch tubing, the third metal ferrule seal 80 comprises a ¼ inch Swagelok® front ferrule and a ¼ inch Swagelok® rear ferrule.

The forward portion 78 of the preferred embodiment of the rear nut 70 includes a male threaded connection 76 for threaded engagement with the female threaded connection 36 on the internal passageway 25 of the seal body 20. The outermost surface of the forward portion 78 of rear nut 70 directly engages the rear portion 82 of metal ferrule 80, and indirectly the front portion 84, to force a seal between the metal ferrule 80 and the tubing.

The rear portion 72 of rear nut 70 preferably comprises a hexagonal surface that provides a means for rotating and tightening the male threaded connection of the forward portion 76 into the female threaded connection 36 of the seal body 20. In a preferred embodiment, the hexagonal surface is a ⅝ inch hexagon.

The internal passageway 75 extends through the length of the rear nut 70 to allow the tubing to be passed through the rear nut 70. As will be recognized by those of skill in the art, for 0.250 inch OD tubing, the diameter of the passageway should be slightly large to allow tubing insertion yet tight enough to allow a tight seal to be formed. Preferably, the diameter of the internal passageway 75 is equivalent to the diameter of internal passageway 25.

The surface or control section of an down-hole electrical cable is typically a tubing encapsulated conductor 100. As shown in FIG. 5, a tubing encapsulated conductor 100 generally includes a conductor wire 104 enclosed in insulation and tubing 102. On the terminal end of the tubing encapsulated conductor, there is a conductor connection 106 for electrically connecting with the instrumentation cable section. Tubing encapsulated conductor systems are known to those of skill in the art. While one particular embodiment of the present invention discussed herein is directed to a tubing encapsulated conductor having 0.250 OD, as persons of ordinary skill in the art will recognize, the invention can be adapted to any commercially available diameter tubing. Preferably, the present invention is utilized with 0.125 to 0.500 inch OD tubing systems, more preferably, 0.125 to 0.250 inch OD tubing systems.

As shown in FIGS. 4(a) and (b), a preferred embodiment of the invention includes an electrical connection housing 90. The electrical connection housing 90 is where the surface or control section of the electrical cable is electrically connected to the instrumentation side of the electrical cable. The hydraulic dam portion 92 and electrical connection portion of the electrical connection housing 90 are known in the prior art as will be recognized by those of skill in the art. Unique to the electrical connection housing 92 of the preferred embodiment of the present invention is the combination and arrangement of female threaded connections 104 and 98 and the conical sections 100 and 102 on the internal passageway 96. These features are specifically developed to secure forward nut 50 and seal body 20 to the electrical connection housing 90 and to accommodate the first and second metal ferrule when engaged to form the seals with the tubing.

As shown in FIG. 6, the components of the preferred embodiment discussed above are assembled together to form an electrical connector with a dual metal to metal seal. As will now be recognized, there are a number of different ways in which the components of the preferred embodiment can be assembled together. Initially, front portion 28 and mid-section 26 of the unitary seal body are inserted through passageway 58 of the forward nut 50 until the forward nut 50 resides over the seal body midsection 26. First and second metal ferrules 60 and 40 are inserted into the conical sections 100 and 102, respectively. The male threaded connection on the forward end 28 of the seal body is engaged with the female threaded connection 98 on the electrical connection housing 90 and the male threaded connection on the forward end 54 of the front nut is engaged with the female connection 104 on the electrical connection housing 90. The third metal ferrule seal 80 is inserted into the conical section 34 of the seal body 20 and then the male threaded connection 76 on the rear nut is engaged with the female threaded connection 36 of the seal body. The tubing encapsulated connector is inserted through the rear nut, seal body, and forward nut and connection to the instrumentation electrical connection and firmly pressed until the tubing contacts a shoulder (stop) inside the forward portion 94 of housing 90. Once the tubing is firmly engaged in the housing 90, the seal body 20, the forward nut 50, and the rear nut 70 are tightened to engage and compress the metal ferrules 40, 60, and 80 to form metal to metal seals. Preferably, ferrule 40 is engaged first by tightening seal body 20, followed by ferrule 60 by tightening forward nut 50, and finally ferrule 80 is engaged by tightening rear nut 70.

While the embodiment described above largely addresses a tubing encapsulated conductor, the present invention is equally applicable to sealing hydraulic tubing connections. The unitary seal body 20, the forward nut 50, the rear nut 70, and the metal ferrule seals 40, 60, and 80 can be used with hydraulic tubing in the same manner as described above. The electrical connector housing 90 is replaced with a tubing connector housing 190.

As shown in FIG. 7, in a tubing connector assembly, tubing connection housing 190 connects to the unitary seal body 20 and the forward nut 50 in the same manner as the electrical connection housing.

While the preferred embodiments described above utilize metal ferrule seals, the present invention is not so limited. Other forms of ring seals such as a C-ring seal can also be utilized in place of one or more of the metal ferrules without departing from the scope and spirit of the invention. As can be seen in FIG. 8, one alternate embodiment utilizes a C-ring seal 160 in place of the preferred metal ferrule seal.

The materials of construction for the components of the assembly of the present invention can vary depending upon the conditions in which the assembly is to be utilized. As will be recognized by those of skill in the art, material selection depends upon operating conditions such as temperature, pressure, and environment (such as corrosive seawater or sour service environments). In preferred embodiments of the present invention the unitary, metal seal body 20, the forward nut 50, the rear nut 70, and the connection housings are manufactured of a nickel-chromium-iron alloy, such as Inconel 718 NACE, a beryllium copper alloy, or titanium.

As will be now be recognized by those of skill in the art, the present invention can be designed for operation in a wide variety of temperature and pressures. The preferred embodiments of the present invention are designed for high pressure operation, including pressures ranging from about 5,000 psi to about 40,000 psi and for temperatures up to about 450 F.

As will now be recognized by those of skill in the art, the connection assembly of the present invention provides several significant manufacturing and assembly advantages. Preferred embodiments of the present invention are easily assembled from the component parts and require no welding on the rig floor which increases safety, productivity, and reliability. Also, the preferred embodiments use of metal ferrules, as opposed to C-ring seals, provide more forgiving surfaces and less polishing of the metal surfaces. Higher quality can be ensured by factory manufacturing processes rather than field procedures performed at the well site.

The foregoing disclosure and description are illustrative and explanatory thereof, and various changes in the details of the illustrated apparatus and construction and method of operation may be made without departing from the spirit in scope of the invention.

We claim:

1. An electrical connector assembly for securely connecting a tubing encapsulated conductor, comprising
a first metal ferrule;
a second metal ferrule;
a third metal ferrule;
a forward nut comprising a forward portion having a male threaded connection on an external surface, a rear portion having external shoulders to assist with rotation of the forward nut, and an internal passageway proceeding from the rear portion through the forward portion;
a unitary, metal seal body, said body having a forward end, a midsection, a back end, and an internal passageway proceeding from the backend through the forward end for receiving a tubing encapsulated conductor;
a rear nut comprising a forward portion having a male threaded connection on an external surface, a rear portion having external shoulders to assist with rotation of the rear nut, and an internal passageway proceeding from the rear portion through the forward portion for receiving a tubing encapsulated conductor; and
an electrical connection housing;
wherein said seal body forward end extends through the internal passageway of said forward nut;
wherein an external surface of the seal body midsection comprises a metal sealing surface for engagement with said first metal ferrule to provide a first metal to metal seal;
wherein said forward portion of said forward nut compresses said first metal ferrule to energize the metal to metal seal;
wherein said forward end of said seal body compresses the second ferrule to create a second metal to metal seal between said second ferrule and the tubing encapsulated conductor;
wherein the internal passageway of the seal body proximate to the rear end comprises a female threaded connection for engagement with the male threaded connection of the forward portion of the rear nut; and
wherein the forward portion of said rear nut compresses the third ferrule to create a metal to metal seal between said third ferrule and the tubing encapsulated conductor.

2. The assembly of claim 1 wherein the rear end of said seal body comprises external shoulders to assist with rotation of the seal body, and rotation of the seal body cause compression of the second ferrules to create the second metal to metal seal.

3. The assembly of claim 1, wherein the external surface of the seal body midsection slidably engages the internal passageway of said forward nut.

4. The assembly of claim 1, wherein the forward end of said seal body comprises a male threaded connection on an external surface.

5. The assembly of claim 1, wherein the electrical connector housing comprises at least one female threaded connection.

6. The assembly of claim 1, wherein the assembly is pressure rated for services between about 5000 psi and about 40,000 psi.

7. The assembly of claim 1, wherein the internal passageway of said seal body comprises a diameter of between about 0.125 and about 0.500 inches.

8. The assembly of claim 1, wherein the internal passageway of said seal body comprises a diameter of between about 0.125 and about 0.250 inches.

9. The assembly of claim 1, wherein the seal body comprises a nickel-chromium-iron alloy.

10. The assembly of claim 1, wherein the seal body comprises a beryllium copper alloy.

11. The assembly of claim 1, wherein the seal body comprises titanium.

12. An electrical connector assembly, comprising:
a unitary, metal seal body, said body having a forward end, a midsection, a back end, and an internal passageway proceeding from the backend through the forward end for receiving a tubing encapsulated conductor;
wherein an external surface of the seal body midsection comprises a metal sealing surface for a first metal to metal seal, and said forward end comprises a surface for energizing a second metal to metal seal.

13. The assembly of claim 12, further comprising:
a forward nut comprising a forward portion having a male threaded connection on an external surface, a rear portion having external shoulders to assist with rotation of the forward nut, and an internal passageway proceeding from the rear portion through the forward portion;
a rear nut comprising a forward portion having a male threaded connection on an external surface, a rear portion having external shoulders to assist with rotation of the rear nut, and an internal passageway proceeding from the rear portion through the forward portion for receiving a tubing encapsulated conductor; and
an electrical connection housing.

14. The apparatus of claim 13, further comprising three metal sealing rings.

15. The apparatus of claim 14, wherein the three metal sealing rings comprise metal ferrules.

16. The apparatus of claim 14, wherein at least one of the metal sealing rings comprises a metal C-ring seal.

17. The apparatus of claim 14, wherein said seal body forward end extends through the internal passageway of said forward nut; wherein the sealing surface on the external surface of the seal body midsection engages with said first metal seal ring to provide the first metal to metal seal; wherein said forward portion of said forward nut compresses said first metal seal ring to energize the metal to metal seal; wherein said forward end of said seal body compresses the second metal seal ring to create the second metal to metal seal between said second metal seal ring and said electrical connection housing; wherein the internal passageway of the seal body proximate to the rear end comprises a female threaded connection for engagement with the male threaded connection of the forward portion of the rear nut; and wherein the forward portion of said rear nut compresses the third metal seal ring to create the metal to metal seal between said third ferrule and the tubing encapsulated conductor.

18. The assembly of claim 17 wherein the rear end of said seal body comprises external shoulders to assist with rotation of the seal body, and rotation of the seal body cause compression of the second metal seal ring to create the second metal to metal seal.

19. The assembly of claim 17, wherein the external surface of the seal body midsection slidably engages the internal passageway of said forward nut.

20. The assembly of claim 17, wherein the forward end of said seal body comprises a male threaded connection on an external surface.

21. The assembly of claim 17, wherein the electrical connector housing comprises at least one female threaded connection.

22. The assembly of claim 17, wherein the assembly is pressure rated for services between about 5000 psi and about 40,000 psi.

23. The assembly of claim 17, wherein the internal passageway of said seal body comprises a diameter of between about 0.125 and about 0.500 inches.

24. The assembly of claim 17, wherein the internal passageway of said seal body comprises a diameter of between about 0.125 and about 0.250 inches.

25. The assembly of claim 17, wherein the seal body comprises a nickel-chromium-iron alloy.

26. The assembly of claim 17, wherein the seal body comprises a beryllium copper alloy.

27. The assembly of claim 17, wherein the seal body comprises titanium.

28. A tubing connector assembly, comprising:
a unitary, metal seal body, said body having a forward end, a midsection, a back end, and an internal passageway proceeding from the backend through the forward end for receiving tubing;
wherein an external surface of the seal body midsection comprises a metal sealing surface for a first metal to metal seal, and said forward end comprises a surface for energizing a second metal to metal seal.

29. The assembly of claim 28, further comprising:
a forward nut comprising a forward portion having a male threaded connection on an external surface, a rear portion having external shoulders to assist with rotation of the forward nut, and an internal passageway proceeding from the rear portion through the forward portion;
a rear nut comprising a forward portion having a male threaded connection on an external surface, a rear portion having external shoulders to assist with rotation of the rear nut, and an internal passageway proceeding from the rear portion through the forward portion for receiving tubing; and
a tubing connection housing.

30. The apparatus of claim 29, further comprising three metal sealing rings.

31. The apparatus of claim 30, wherein the three metal sealing rings comprise metal ferrules.

32. The apparatus of claim 30, wherein at least one of the metal sealing rings comprises a metal C-ring seal.

33. The apparatus of claim 30, wherein said seal body forward end extends through the internal passageway of said forward nut; wherein the sealing surface on the external surface of the seal body midsection engages with said first metal seal ring to provide the first metal to metal seal; wherein said forward portion of said forward nut compresses said first metal seal ring to energize the metal to metal seal; wherein said forward end of said seal body compresses the second metal seal ring to create the second metal to metal seal between said second metal seal ring and said tubing connection housing; wherein the internal passageway of the seal body proximate to the rear end comprises a female threaded connection for engagement with the male threaded connection of the forward portion of the rear nut; and wherein the forward portion of said rear nut compresses the third metal seal ring to create the metal to metal seal between said third ferrule and the tubing.

34. The assembly of claim 33 wherein the rear end of said seal body comprises external shoulders to assist with rotation of the seal body, and rotation of the seal body cause compression of the second metal seal ring to create the second metal to metal seal.

35. The assembly of claim 33, wherein the external surface of the seal body midsection slidably engages the internal passageway of said forward nut.

36. The assembly of claim 33, wherein the forward end of said seal body comprises a male threaded connection on an external surface.

37. The assembly of claim 33, wherein the electrical connector housing comprises at least one female threaded connection.

38. The assembly of claim 33, wherein the assembly is pressure rated for services between about 5000 psi and about 40,000 psi.

39. The assembly of claim 33, wherein the internal passageway of said seal body comprises a diameter of between about 0.125 and about 0.500 inches.

40. The assembly of claim 33, wherein the internal passageway of said seal body comprises a diameter of between about 0.125 and about 0.250 inches.

41. The assembly of claim 33, wherein the seal body comprises a nickel-chromium-iron alloy.

42. The assembly of claim 33, wherein the seal body comprises a beryllium copper alloy.

43. The assembly of claim 33, wherein the seal body comprises titanium.
